(19) United States
(12) Patent Application Publication
(10) Pub. No.: US 2012/0188947 A1
(43) Pub. Date: Jul. 26, 2012

(54) Uplink Power Control in Wireless Communication Systems

(76) Inventors: Daniel Larsson, Solna (SE); Dirk Gerstenberger, Stockholm (SE); Lars Lindbom, Karlstad (SE)

(21) Appl. No.: 13/499,043

(22) PCT Filed: Jun. 9, 2010
(86) PCT No.: PCT/SE10/50641

§ 371 Date: Mar. 29, 2012

Related U.S. Application Data
(60) Provisional application No. 61/248,085, filed on Oct. 2, 2009.

(51) Int. Cl. H04W 52/04

(52) U.S. Cl. 370/328

(57) ABSTRACT

Methods in a Long Term Evolution (LTE) base station for controlling transmit power of a User Equipment(UE) are provided. The method includes configuring UE individual power weighting factors to be used for weighting available UE transmit power between uplink component carriers and/or between Physical Uplink Control Channel (PUCCH) and Physical Uplink Shared Channel (PUSCH); and signaling the configured UE individual power weighting factors to the UE. Related methods and arrangements are also provided.

### TECHNICAL FIELD

The present invention relates to methods and arrangements in a wireless telecommunication network, and in particular to distribution of available User Equipment (UE) transmit power over different component carriers and/or over physical uplink shared channels (PUSCH) and physical uplink control channels (PUCCH).

### BACKGROUND

3GPP Long Term Evolution (LTE) is a project within the 3^{rd} Generation Partnership Project (3GPP) to evolve the UMTS standard towards the fourth generation of mobile telecommunication networks. In comparisons with UMTS, LTE provides increased capacity, much higher data peak rates and significantly improved latency numbers. For example, the LTE specifications support downlink data peak rates up to 300 Mbps, uplink data peak rates of up to 75 Mbit/s and radio access network round-trip times of less than 10 ms. In addition, LTE supports scalable carrier bandwidths from 20 MHz down to 1.4 MHz and supports both FDD (Frequency Division Duplex) and TDD (Time Division Duplex).

LTE uses OFDM in the downlink and DFT (Discrete Fourier Transform)-spread OFDM in the uplink. The basic LTE downlink physical resource can be seen as a time-frequency grid as illustrated in FIG. 1, where each resource element corresponds to one OFDM subcarrier during one OFDM symbol interval.

In the time domain, LTE downlink transmissions are organized into radio frames of 10 ms, each radio frame consisting of ten equally-sized subframes of length T_{subframe}=1 ms as illustrated in FIG. 2.

Furthermore, the resource allocation in LTE is typically described in terms of resource blocks, where a resource block corresponds to one slot which is 0.5 ms in the time domain and 12 contiguous subcarriers in the frequency domain. The resource blocks are numbered in the frequency domain, starting with 0 from one end of the system bandwidth.

Downlink transmissions are dynamically scheduled, i.e., in each subframe the base station transmits control information comprising information about to which terminals data will be transmitted and upon which resource blocks the data will be transmitted, in the current downlink subframe. This control signaling is typically transmitted in the first 1, 2, 3 or 4 OFDM symbols in each subframe. A downlink system with 3 OFDM symbols as control is illustrated in FIG. 3.

LTE uses hybrid-ARQ, where, after receiving downlink data in a subframe, the terminal attempts to decode it and reports to the base station whether the decoding was successful by sending an ACK or not NAK. In case of an unsuccessful decoding attempt, the base station can retransmit the erroneous data.

Uplink control signaling from the terminal to the base station consists of hybrid-ARQ acknowledgements for received downlink data; terminal reports related to the downlink channel conditions, used as assistance for the downlink scheduling; scheduling requests, indicating that a mobile terminal needs uplink resources for uplink data transmissions.

If the mobile terminal has not been assigned an uplink resource for data transmission, the L1/L2 control information, exemplified by channel-status reports, hybrid-ARQ acknowledgments, and scheduling requests, is transmitted in uplink resources, i.e. in the resource blocks, specifically assigned for uplink L1/L2 control on the Physical Uplink Control Channel (PUCCH). These resources are located at the edges of the total available cell bandwidth. Each such resource consists of twelve “subcarriers”, i.e. one resource block within each of the two slots of an uplink subframe. In order to provide frequency diversity, these frequency resources are frequency hopping on the slot boundary, i.e. one “resource” consists of 12 subcarriers at the upper part of the spectrum within the first slot of a subframe and an equally sized resource at the lower part of the spectrum during the second slot of the subframe or vice versa. If more resources are needed for the uplink L1 /L2 control signaling, e.g. in case of very large overall transmission bandwidth supporting a large number of users, additional resources blocks can be assigned next to the previously assigned resource blocks.

The reasons for locating the PUCCH resources at the edges of the overall available spectrum are:
Together with the frequency hopping described above, the location of the PUCCH resources at the edges of the overall available spectrum maximizes the frequency diversity experienced by the control signaling.
Assigning uplink resources for the PUCCH at other positions within the spectrum, i.e. not at the edges, would have fragmented the uplink spectrum, making it impossible to assign very wide transmission bandwidths to single mobile terminal and still retain the single-carrier property of the uplink transmission.

The bandwidth of one resource block during one subframe is too large for the control signaling needs of a single terminal. Therefore, to efficiently exploit the resources set aside for control signaling, multiple terminals can share the same resource block. This is done by assigning the different terminals different orthogonal phase rotations of a cell-specific length-12 frequency-domain sequence. A linear phase rotation in the frequency domain is equivalent to applying a cyclic shift in the time domain. Thus, although the term “phase rotation” is used herein, the term cyclic shift is sometimes used with an implicit reference to the time domain.

The resource used by a PUCCH is therefore not only specified in the time-frequency domain by the resource-block pair, but also by the phase rotation applied. Similarly to the case of reference signals, there are up to twelve different phase rotations specified, providing up to twelve different orthogonal sequences from each cell-specific sequence. However, in the case of frequency-selective channels, not all the twelve phase rotations can be used if orthogonality is to be retained. Typically, up to six rotations are considered usable in a cell.

To transmit data in the uplink the mobile terminal has to be assigned an uplink resource for data transmission, on the Physical Uplink Shared Channel (PUSCH). In contrast to a data assignment in downlink, in uplink the assignment must always be consecutive in frequency, this to retain the signal carrier property of the uplink as illustrated in FIG. 4.

The middle SC-symbol in each slot is used to transmit a reference symbol. If the mobile terminal has been assigned an uplink resource for data transmission and at the same time instance has control information to transmit, it will transmit the control information together with the data on PUSCH.

Uplink power control is used both on the PUSCH and on PUCCH. The purpose is to ensure that the mobile terminal transmits with sufficient power, but at the same time not be too high, since that would only increase the interference to other users in the network. In both cases, a parameterized open loop combined with a closed loop mechanism is used. Roughly, the open loop part is used to set a point of operation, around which the closed loop component operates.

In more detail, for PUSCH the mobile terminal sets the output power according to

P_{PUSCH}(i)=min{P_{CMAX}, 10 log₁₀ (M_{PUSCH}(i))+P_{O}_{_{—}}_{PUSCH}(j)+α·PL+Δ_{TF}(i)+f(i)}[dBm],

where P_{CMAX} is the configured maximum transmit power for the mobile terminal, M_{PUSCH}(i) is the number resource blocks assigned, P_{O}_{_{—}}_{PUSCH}(j) and α control the target received power, PL is the estimated pathloss, Δ_{TF}(i) is transport format compensator and f(i) is the a UE specific offset or ‘closed loop correction’ (the function f may represent either absolute or accumulative offsets).

The closed loop power control can be operated in two different modes either accumulated or absolute. Both modes are based on a TPC (Transmit power command) which is part of the downlink control signaling. When absolute power control is used, the closed loop correction function is reset every time a new power control command is received. When accumulated power control is used, the power control command is a delta correction with regard to the previously accumulated closed loop correction. The base station can filter the mobile terminals power in both time and frequency to provide an accurate power control operating point for the mobile terminal. The accumulated power control command is defined as f(i)=f(i−1)+δ_{PUSCH}(i−K_{PUSCH}), where δ_{PUSCH} is the TPC command received in K_{PUSCH} subframe before the current subframe i and f(i−1) is the accumulated power control value.

The accumulated power control command is reset when

changing cell, entering/leaving RRC active state, an absolute TPC command is received,

P_{0 PUSCH} is received, and when the mobile terminal (re)synchronizes.

In the case of reset the power control command is reset to f(0)=ΔPᵣₐₘₚᵤₚ+δ_{msg2}, where δ_{msg2} is the TPC command indicated in the random access response and ΔPᵣₐₘₚᵤₚ corresponds to the total power ramp-up form the first to the last random access preamble.

The PUCCH power control has in principle the same configurable parameters with the exception that PUCCH only has full pathloss compensation, i.e. does only cover the case of α=1.

In LTE Rel-8, the base station has the possibility to request a power headroom report from the UE for PUSCH transmissions. The power headroom reports inform the base station how much remaining transmission power the UE has for the subframe i. The reported value is within the range of 40 to −23 dB, where a negative value indicates that the UE does not have enough amount of transmit power to fully conduct the transmission of data, or control information.

The UE power headroom (PH) for subframe i is defined as

PH(i)=P_{CMAX}−{10 log₁₀ (M_{PUSCH}(i)+P_{O}_{_{—}}_{PUSCH}(j)+α(j)·PL+Δ_{TF}(i)+f(i)}

where P_{CMAX}, M_{PUSCH}(i) P_{O}_{_{—}}_{PUSCH}(j), α(j), PL, Δ_{TF}(i) and f(i) is defined above.

In order to further improve the LTE, LTE advanced, from LTE release 10, is introduced. With LTE advanced it will be possible to transmit PUCCH and PUSCH at the same occasion and to transmit/receive on multiple component carriers.

With the added possibility for the UE to transmit PUSCH and PUCCH at the same occasion, the scenario of power limitation, i.e. when the UE has reached the maximum transmit power, becomes more likely.

### SUMMARY

As both of the physical channels PUSCH and PUCCH can be transmitted at the same occasion the available transmit power in the UE needs to be shared between the two channels. The PUCCH has a separate power control loop from the PUSCH and the power control loops are separated between the uplink component carriers, therefore the base station have to control how the UE is distributing the available transmit power between multiple UL component carriers and between PUCCH and PUSCH according to the present invention.

Furthermore, there is a need to control the distribution of UE transmit power between multiple UL component carriers, e.g. in situations where the UL component carriers reside in different bands or where data with different importance are scheduled onto the different component carriers.

To be able to control the distribution of the available transmit power of a UE between multiple UL component carriers and/or between PUCCH and PUSCH, individual power weighting factors to be used by the UE are configured by the eNB according to embodiments of the present invention. The power weighting factors are signaled to the UE accordingly and used by the UE to weight PUCCH and PUSCH and/or different component carriers.

According to a first aspect of the present invention a method in a base station for controlling transmit power of a UE is provided. In the method, UE individual power weighting factors are configured to be used for weighting available UE transmit power between uplink component carriers and/or between PUCCH and PUSCH, and the configured UE individual power weighting factors are signaled to the UE.

According to a second aspect of the present invention a method in a UE, for controlling transmit power of the UE is provided. In the method UE individual power weighting factors are received to be used for weighting available UE transmit power between uplink component carriers and/or between PUCCH and PUSCH and the received UE individual power weighting factors are applied on the available UE transmit power during transmission.

According to a third aspect of the present invention, a base station for controlling transmit power of a UE is provided. The base station comprises a processor for configuring UE individual power weighting factors to be used for weighting available UE transmit power between uplink component carriers and/or between PUCCH and PUSCH and a transmitter 802 for signaling the configured UE individual power weighting factors to the UE.

According to a fourth aspect of the present invention, a UE for controlling transmit power of the UE is provided, The UE comprises a receiver for receiving UE individual power weighting factors to be used for weighting available UE transmit power between uplink component carriers and/or between PUCCH and PUSCH and a processor for applying the received UE individual power weighting factors on the available UE transmit power during transmission.

An advantage with embodiments of the present invention is that the base station can control the UE transmission power available for multiple UL component carriers, and for PUSCH and PUCCH transmission in case the PUSCH and PUCCH is simultaneously transmitted and when the UE is power limited.

### BRIEF DESCRIPTION OF THE DRAWINGS

FIG. 1 illustrates the LTE downlink physical resources according to prior art.

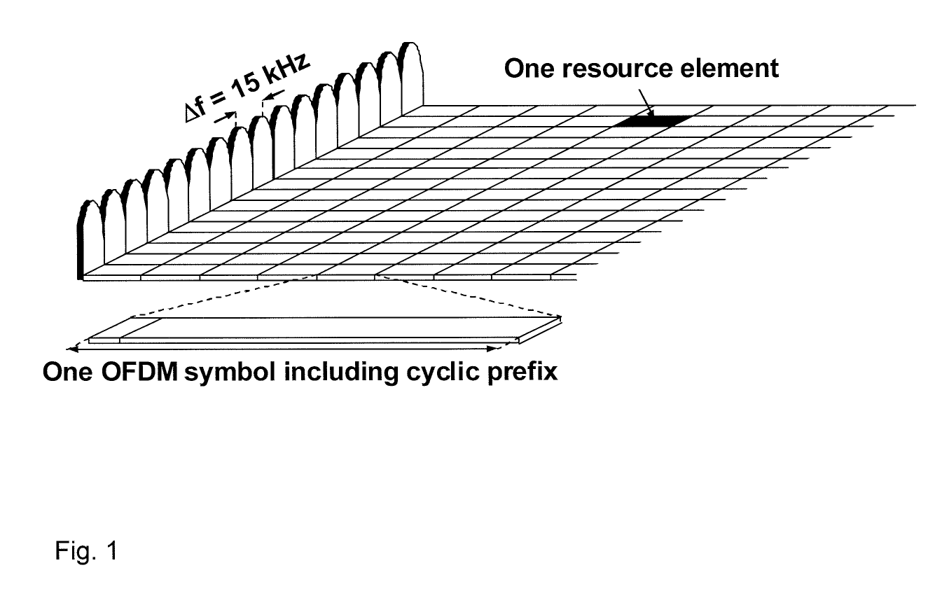

FIG. 2 illustrates the LTE lime-domain structure according to prior art.

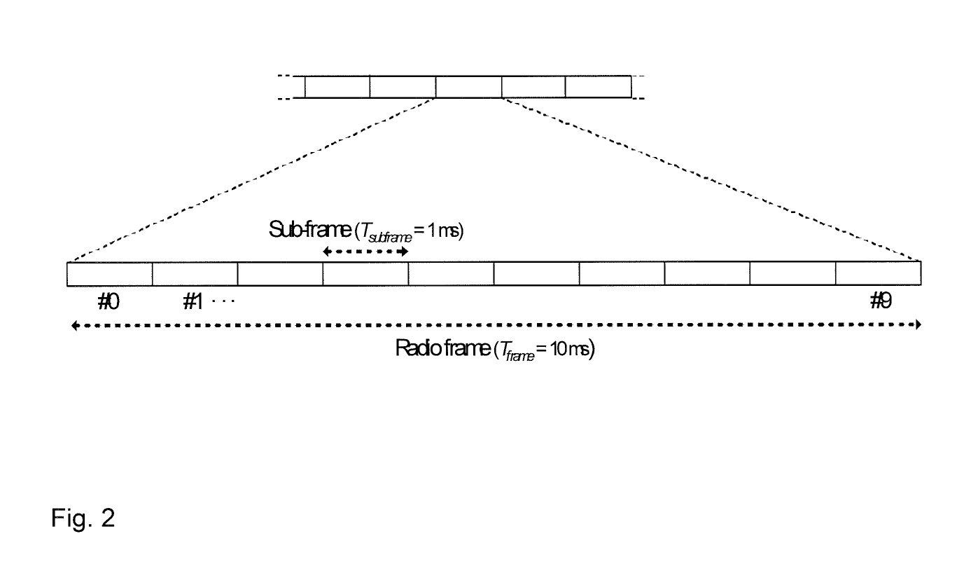

FIG. 3 illustrates the downlink subframes according to prior art.

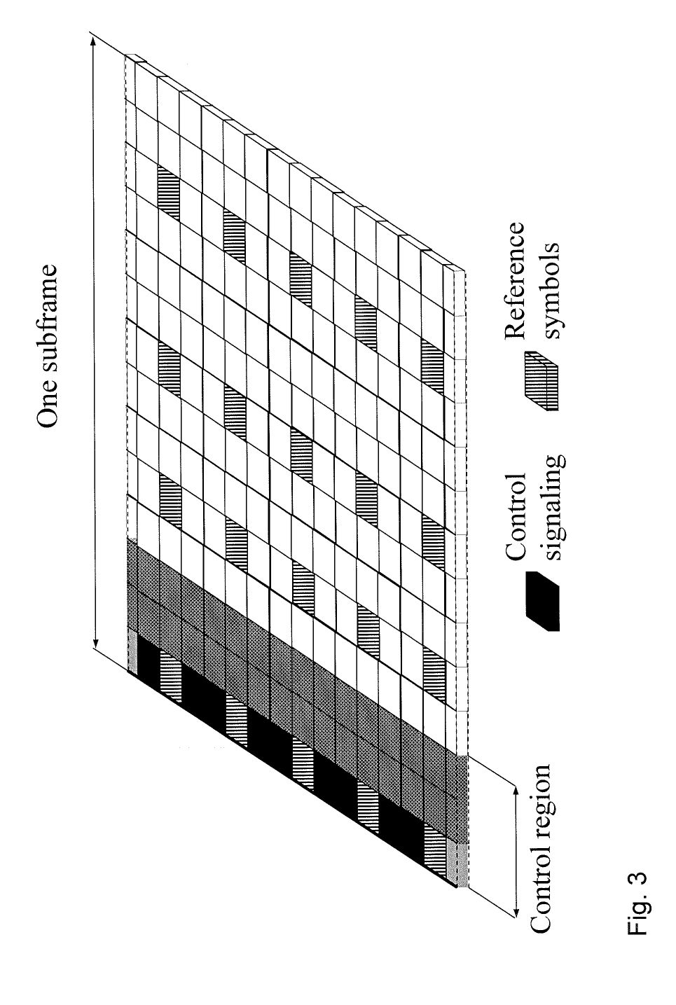

FIG. 4 illustrates an example of resources assigned on PUSCH according to prior art.

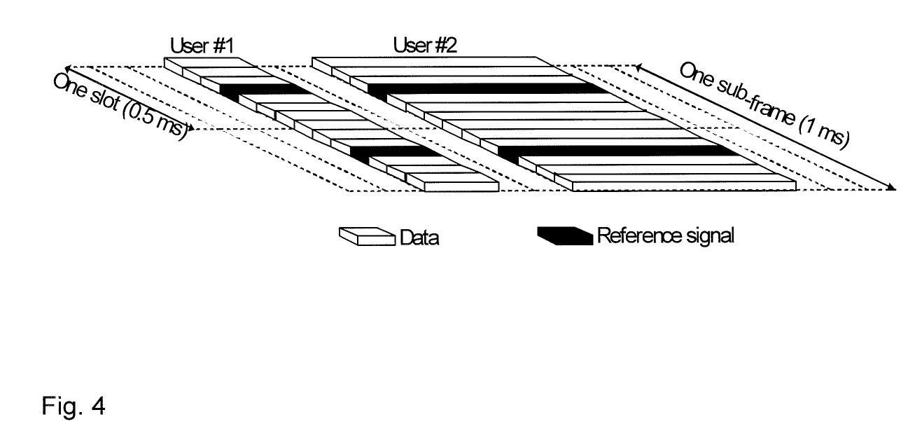

FIG. 5 illustrates a scenario according to an embodiment of the present invention.

FIGS. 6 and 7 are flowcharts of the methods according to embodiments of the present invention.

FIG. 8 illustrates the UE and the base station according to embodiments of the present invention.

### DETAILED DESCRIPTION

The present invention will be described more fully hereinafter with reference to the accompanying drawings, in which preferred embodiments of the invention are shown. The invention may, however, be embodied in many different forms and should not be construed as limited to the embodiments set forth herein;

rather, these embodiments are provided so that this disclosure will be thorough and complete, and will fully convey the scope of the invention to those skilled in the art. In the drawings, like reference signs refer to like elements.

Moreover, those skilled in the art will appreciate that the means and functions explained herein below may be implemented using software functioning in conjunction with a programmed microprocessor or general purpose computer, and/or using an application specific integrated circuit (ASIC). It will also be appreciated that while the present invention is primarily described in the form of methods and devices, the invention may also be embodied in a computer program product as well as a system comprising a computer processor and a memory coupled to the processor, wherein the memory is encoded with one or more programs that may perform the functions disclosed herein.

It should be noted that the embodiments of the present invention will be described in the context of an LTE advanced network, but it should be noted that the invention is applicable in any system having transmission on multiple component carriers and/or when simultaneous transmission on PUSCH and PUCCH is possible.

In case there is transmit power limitation at the UE with simultaneous transmission on PUCCH and PUSCH and/or multiple component carrier, it would be desired to take in the whole situation when resolving the limitation.

Therefore, in order to reduce the PUSCH load, the base station can schedule less data on a given number of uplink component carriers, or schedule PUCCH and PUSCH transmissions such that they do not occur simultaneously. Alternatively, the base station can schedule transmission on a reduced number of uplink component carriers.

In order to reduce the PUCCH load which is dependent on the amount of ACK/NACK, CQI (Channel quality indicator) and SR (scheduling request) transmissions, the base station can reduce the amount of ACK/NACK transmission by scheduling less data on a given number of downlink component carriers, and in addition schedule PUCCH and PUSCH transmissions such that they do not occur simultaneously. To reduce the amount of CQI (channel quality indicator) (or other channel state information), the base station can schedule CQI reports such that they don't coincide with PUSCH transmissions, schedule transmissions on a reduced number of downlink component carriers, or schedule PUCCH and PUSCH transmissions such that they don't occur simultaneously.

In case a scheduling request is to be transmitted with PUSCH, a buffer status report is instead transmitted on PUSCH together with a data payload. Hence the scheduling request does not contribute to the PUCCH load in case PUSCH and PUCCH are transmitted simultaneously.

All these measures can be taken by the base station without need for additional specifications and these mechanisms should primarily be used by the eNB to cope with uplink power limitation.

However on the UE side, if the UE is power limitated, the available UE transmit power is distributed between the PUSCH and the PUCCH and/or between the uplink component carriers according to the present invention in order to avoid exceeding the maximum transmit power. Hence, the eNB determines weighting factors to be applied on the transmit power on the PUSCH and/or PUCCH and/or to each individual component carrier which are used by the UE. The UE uses these weighting factors when determining the transmit power such that the sum of the transmission power on the PUCCH and/or PUSCH which may be distributed over multiple component carriers is below or equal to the maximum available power of the UE. Hence, the power weighting factors can be equal or unequal between different component carriers, which may depend on the type of data scheduled on the component carriers. For example, component carrier specific weighting factors could be used by the UE.

Therefore, as a first embodiment of the present invention, the base station configures weighting factors for each UL (uplink) component carrier and signals the weighting factors to the UE. The weighting factors can either be signaled explicitly or implicitly. In case of implicit signaling the base station signals another piece of information from which the UE can derive which weighting factors to apply. The UE can use the weighting factors to reduce the transmit power on each component carrier until there is no power limitation. It should be noted that since the base station is not aware of the exact amount of available transmit power of the UE, the UE may not simply use the received weighting factors. Instead, the UE may have to perform an additional scaling such that the sum of the transmission power over the multiple component carriers is below or equal to the maximum available power of the UE. An example of this is explained below.

The usage of one or multiple PAs (Power Amplifiers) in the UE for different uplink component carriers is an implementation option, and may depend, e.g. on whether the component carriers are adjacent/non-adjacent or in the same/different bands.

As there is a dependency on the PA implementation in the UE, as a general rule the UE may scale the power on the component carriers such that the following conditions are fulfilled, as explained for the example of two UL component carriers, without any restriction of other UL component carrier configurations, wherein x and y are the weighting factors and z is a scaling factor used for scaling performed by the UE:

1/z((1/x)Power_{—}CC1+(1/y)Power_{—}CC2)≦P_max (1)

In a second embodiment, the eNB can configure an individual weighting factor to be used for PUCCH and PUSCH, in case where PUCCH and PUSCH are transmitted simultaneously and the UE is power limited. The UE would use the weighting factors to adjust the transmit power on PUCCH and PUSCH accordingly, which is illustrated below wherein n and m are the weighting factors and z is the scaling factor used for scaling performed by the UE.

1/z((1/n)Power_PUSCH+(1/m)Power_PUCCH)≦P_{—} P_max (2)

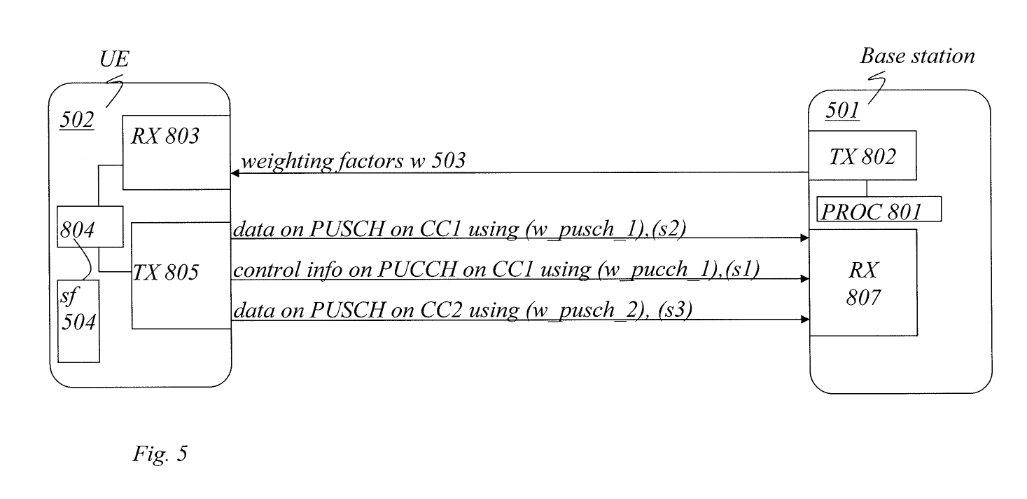

These embodiments are further illustrated by the following example disclosed in FIG. 5. It should be noted that the weighting factors and scaling factors disclosed above are ≧1, while the weights disclosed below are ≦1.

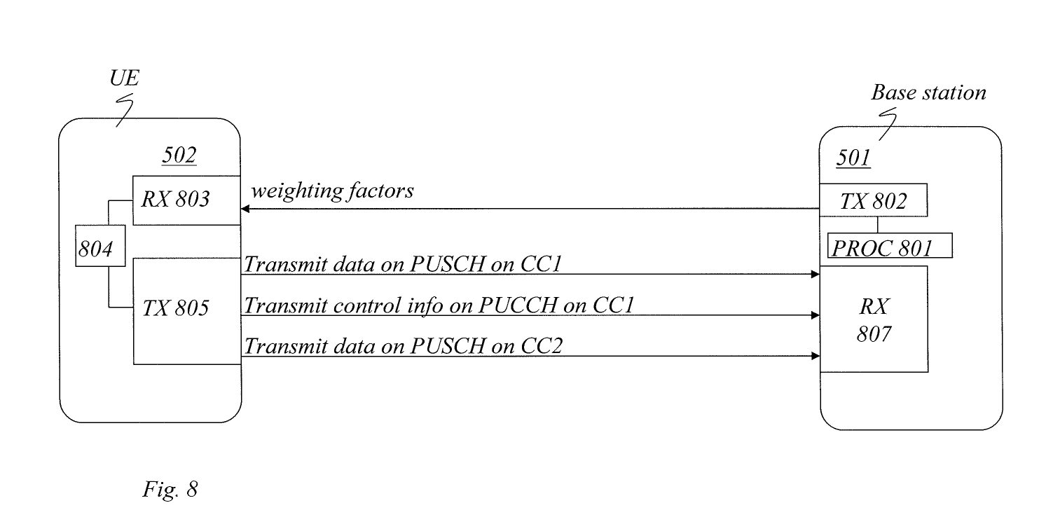

The base station 501 signals to the UE 502 a set of weights ω 503, also referred to as weighting factors, corresponding to the PUCCH and PUSCH for each component carrier. The UE and the base station are further described below in conjunction with FIG. 8.

As an example for two component carriers, the weights would be w_PUCCH_{—}1, w_PUSCH_{—}1, w_PUSCH_{—}2 as illustrated in FIG. 5. As a special case, all signaled weight factors may be set as equal to 1. As a further case, the sum of the weight factors may be equal to 1, and in such a case, only a subset of the weight factors needs to be signaled to the UE, as one of the weight factors can be calculated as 1−(sum of all signaled weight factors).

Thus according to embodiments of the present invention the UE receives the set of weighting factors ω 503 corresponding to the PUCCH and PUSCH for each component carrier, and uses them for distributing the available UE transmit power between the PUCCH and PUSCH and/or between component carriers. In addition, a UE specific scaling factor sf 504 may be applied by a processor 804 of the UE 502, so that the total output power does not exceed the configured maximum output power for the UE, P_cmax.

As an example for two component carriers, the UE determines the scaling factors s=[s1,s2,s3] per PUSCH/PUCCH and each component carrier for scaling its output power such that:

s1*w_PUCCH_{—}1*Power_PUCCH_{—}1+s2*w_PUSCH_{—}1*Power_PUSCH_{—}1+s3*w_PUSCH_{—}2*Power_PUSCH_{—}2≦P_cmax

As a further special case, the network may signal one specific reserved value of a weight factor for PUCCH or PUSCH to indicate that no scaling shall be done on the PUCCH, i.e. the PUCCH would take all available power first, and then the PUSCH would be scaled by the UE with a scaling factor s to be determined by the UE to stay below P_cmax. This behavior could be implemented as a special case of the generic behavior, where for the example of component carrier 1, w_PUCCH_{—}1 would be set by the UE to 1/s and w_PUSCH_{—}1 would be set by the UE equal to 1, if a special reserved value of w_PUCCH_{—}1 or w_PUSCH_{—}1 is signaled, such that:

s*(w_PUCCH_{—}1*Power_PUCCH_{—}1+w_PUSCH_{—}1*Power_PUSCH_{—}1)≦P_cmax

in fact becomes with w_PUCCH_{—}1=1/s and w_PUSCH_{—}1=1:

s*(1/s*Power_PUCCH_{—}1+1*Power_PUSCH_{—}1)≦P_cmax

The special value of w_PUCCH_{—}1 or w_PUSCH_{—}1 may for example be the value zero.

According to one example, initially all available transmit power is allocated to the PUCCH, then the transmit power to the PUSCH is allocated and the available transmit power is therefore distributed between the PUCCH and the PUSCH.

In a third embodiment, the base station is adapted to configure a PUCCH specific weighting factor to weight the transmit power on PUCCH relative to the transmit power on PUSCH, in case where PUCCH and PUSCH are transmitted simultaneously and the UE is power limited.

In a fourth embodiment, the base station is adapted to configure a PUSCH specific weighting factor to scale the transmit power on PUSCH relative to the transmit power on PUCCH, in case where PUCCH and PUSCH are transmitted simultaneously and the UE is power limited.

In a fifth embodiment, the base station is adapted to configure component carrier specific individual weighting factors according to any of the second, third and fourth embodiments. I.e., the base station may configure component specific individual weighting factors for PUSCH and PUCCH as for example:

1/z((1/n)Power_PUSCH CC1+(1/m)Power_PUCCH CC1+(1/k)Power_PUSCH CC2+(1/1)Power_PUCCH CC2)≦P_max

N, m, k and 1 are the weighting factors, z is the UE scaling factor and CC1 is a first component carrier and CC2 is a second component carrier.

Further, the base station may be adapted to configure component carrier specific individual weighting factors for PUCCH specific weighting factors to scale the transmit power on PUCCH relative to the transmit power on PUSCH. Alternatively, the base station may be adapted to configure component carrier specific individual weighting factors for PUSCH specific weighting factors to scale the transmit power on PUSCH relative to the transmit power on PUCCH.

A yet further embodiment provides an alternative solution to distribute the power between the UL component carrier. The alternative solution implies that one or several uplink component carriers is/are prioritized such that the power is first reduced on the non-prioritised component carriers. The reason for prioritizing one or more uplink component carriers is that the information carried on these component carriers should be protected. The information to be protected is typically control information transmitted on the PUCCH or the PUSCH. Examples of control information transmitted on the PUCCH are CQI reports and control information transmitted together with data on the PUSCH is ACK/NACK indicators. Thus the prioritized component carriers may be PUCCH and PUSCH used for control data.

Hence according to this embodiment the network has to inform the UE about which UL component carriers that are prioritized, and this could be done e.g. by using a specific reserved value, e.g. the value zero, of the weight factor for the PUSCH on the respective component carrier. The UE will behave according to the principle below:

When the UE reaches the maximum total transmission power, the UE should first weight the component carriers with weights provided by the network. The weights may e.g. be set such that one or several component carriers are prioritized, i.e. the allocated power on the prioritized component carriers is not weighted downwards. However, if after the weighting factors are applied, the UE is still reaching power limitation, the UE should share the available transmit power equally between the prioritized carriers.

This further embodiment is exemplified by the example where the total UE transmit power exceeds the UE maximal transmit power P_{CMAX}. In this case the

UE scales the transmit power of each PUSCH such that

$${\sum }_{c} {w}_{c} \cdot {P}_{{PUSCH}_{c}} ( i ) \leq {P}_{CMAX} - {P}_{PUCCH} ( i )$$

where w_{c} is a scaling factor for PUSCH on carrier c.

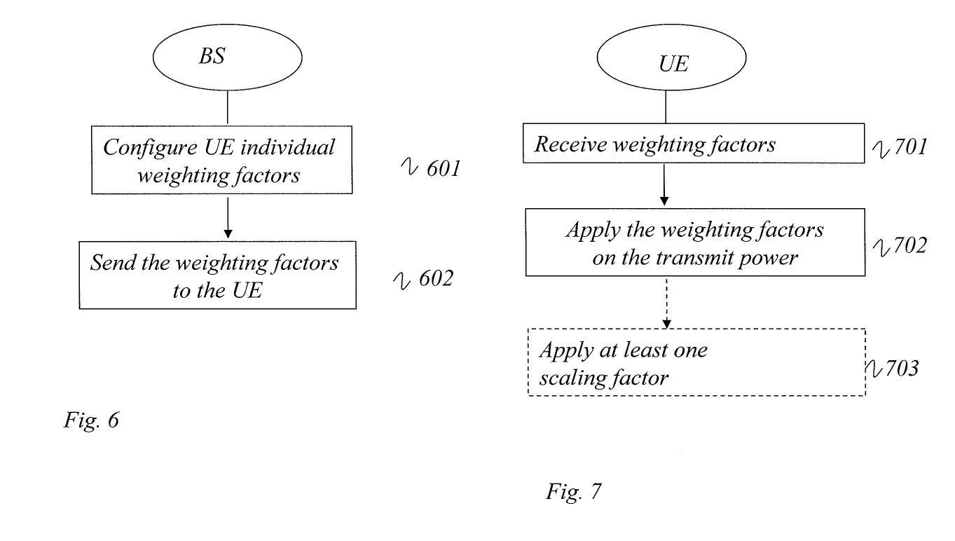

Turning now to FIGS. 6 and 7, illustrating the methods according to embodiments of the present invention.

In a first step the base station configures 601 UE individual power weighting factors, weighting the power to be used in the transmission by the UE on PUCCH and/or PUSCH and/or between multiple component carriers. In a second step, the base station signals 602 the configured power weighting factors to the UE.

The UE receives 701 the UE individual configured power weighting factors, weighting the power to be used in the transmission by the UE and applying 702 the weighting factors and scaling the total UE transmit power when transmitting on the PUCCH and/or the PUSCH and/or on multiple component carriers. In addition, at least one scaling factor (sf) may be applied 703 when transmitting on the PUCCH and/or the PUSCH and/or on multiple component carriers such that the sum of the transmission power on the PUCCH and/or PUSCH which may be distributed over multiple component carriers is below or equal to the maximum available power of the UE.

Thus according to an embodiment, the power to be used in the transmission by the UE may either be scaled 703 with respect to PUSCH and PUCCH or with respect to different component carriers if multiple component carriers are being used as explained above, or in a combination thereof. As an example, only prioritized component carriers carrying control information are scaled.

The present invention is also directed to a UE (User Equipment) and a base station, also referred to as an eNB in LTE. The UE is configured to wirelessly communicate with a mobile telecommunication network via base stations. Hence, the UE and the base station comprise antennas, power amplifiers and other software means and electronic circuitry enabling the wireless communication. FIG. 8 illustrates schematically a UE 502 and a base station 501.

Accordingly, the base station 501 is adapted to distribute the available transmit power of a UE 502 between multiple uplink component carriers and/or between PUCCH and PUSCH. The base station 501 comprises a processor 801 for configuring individual power weighting factors distributing the power to be used in the transmission by the UE 502 between the PUCCH and PUSCH and/or between uplink component carriers when transmitting on the PUCCH and the PUSCH simultaneously. Furthermore, the base station 501 comprises a transmitter 802 for signaling the configured power weighting factors to the UE 502 and a receiver 807 for receiving data and control information on which the configured weighting factors are applied.

According to one embodiments of the present invention, the processor 801 is configured to configure UE individual power weighting factors to be used for weighting available UE transmit power between component carriers. The processor 801 may also be configured to prioritize component carriers by configuring the UE individual power weighting factors such that the PUSCH power is first reduced on the non-prioritised component carriers.

According to a further embodiment, the processor 801 is configured to configure UE individual power weighting factors to be used for weighting available UE transmit power between PUCCH and PUSCH. Further, the processor may be configured to configure a PUCCH specific weighting factor to weight the transmit power on PUCCH relative to the transmit power on PUSCH or to weight the transmit power on PUSCH relative to the transmit power on PUCCH.

Accordingly, the UE 502 is adapted to distribute the available transmit power of a UE 502 between multiple uplink component carriers and/or between PUCCH and PUSCH. The UE 502 comprises a receiver 803 for receiving the individual configured power weighting factors. The UE 502 further comprises a processor 804 for applying the weighting factors and distributing the total UE transmit power. In addition to the received weighting factors the processor 804 is adapted to apply at least one scaling factor sf 504 (FIG. 5) when transmitting by the transmitter 805 on the PUCCH and/or the PUSCH and/or on multiple component carriers such that the sum of the transmission power on the PUCCH and/or PUSCH which may be distributed over multiple component carriers is below or equal to the maximum available power of the UE.

According to embodiments of the present invention, the receiver 803 is configured to receive a PUCCH specific weighting factor to be used by the processor 804 to weight the transmit power on PUCCH relative to the transmit power on PUSCH or to weight the transmit power on PUSCH relative to the transmit power on PUCCH.

In addition, the processor 804 may be further configured to apply a respective scaling factor 504 on the received weighting factors to scale the distributed available transmit power between component carriers and/or between PUSCH and PUCCH.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A method in a Long Term Evolution (LTE) base station for controlling transmit power of a User Equipment (UE), the method comprising:
configuring UE individual power weighting factors to be used for weighting available UE transmit power between uplink component carriers and/or between Physical Uplink Control Channel (PUCCH) and Physical Uplink Shared Channel, PUSCH (PUSCH); and
signaling the configured UE individual power weighting factors to the UE.

2. The method of claim 1, wherein the configured UE individual power weighting factors are signaled implicitly to the UE.

3. The method of claim 1, wherein the configured UE individual power weighting factors are signaled explicitly to the UE.

4. The method of claim 1, wherein the base station configures UE individual power weighting factors to be used for weighting available UE transmit power between component carriers.

5. The method of claim 4, wherein one or more uplink component carriers are prioritized by configuring the UE individual power weighting factors such that PUSCH power is first reduced on non-prioritized component carriers.

6. The method of claim 5, wherein the prioritized uplink component carriers are configured to carry control information.

7. The method of claim 1, wherein the base station configures UE individual power weighting factors to be used for weighting available UE transmit power between PUCCH and PUSCH.

8. The method of claim 7, wherein the base station configures a PUCCH specific weighting factor to weight transmit power on PUCCH relative to transmit power on PUSCH.

9. The method of claim 7, wherein the base station configures a PUSCH specific weighting factor to weight transmit power on PUSCH relative to transmit power on PUCCH.

10. A method in a Long Term Evolution (LTE) User Equipment (UE) for controlling transmit power of the UE, the method comprising:
receiving UE individual power weighting factors to be used for weighting available UE transmit power between uplink component carriers and/or between Physical Uplink Control Channel (PUCCH) and Physical Uplink Shared Channel (PUSCH); and
applying the received UE individual power weighting factors on the available UE transmit power during transmission.

11. The method of claim 10, wherein the configured UE individual power weighting factors are signaled implicitly from a base station.

12. The method of claim 10, wherein the configured UE individual power weighting factors are signaled explicitly from a base station.

13. The method of claim 10, wherein the UE individual power weighting factors are received to be used for weighting available UE transmit power between component carriers.

14. The method of claim 13, wherein one or more uplink component carriers are prioritized by receiving UE individual power weighting factors configured such that the power is first reduced on non-prioritized component carriers.

15. The method of claim 14, wherein the prioritized uplink component carriers are configured to carry control information.

16. The method of claim 10, wherein the UE individual power weighting factors are received to be used for weighting available UE transmit power between PUCCH and PUSCH.

17. The method of claim 16, wherein a PUCCH specific weighting factor is received to weight transmit power on PUCCH relative to transmit power on PUSCH.

18. The method of claim 16, wherein a PUSCH specific weighting factor is received to weight transmit power on PUSCH relative to transmit power on PUCCH.

19. The method of claim 10, further comprising:
applying a respective scaling factor on the received weighting factors to scale the distributed available transmit power between component carriers and/or between PUSCH and PUCCH.

20. A Long Term Evolution (LTE) base station for controlling transmit power of a User Equipment (UE) the base station
a processor for configuring UE individual power weighting factors to be used for weighting available UE transmit power between uplink component carriers and/or between Physical Uplink Control Channel (PUCCH) and Physical Uplink Shared Channel (PUSCH) and a transmitter for signaling the configured UE individual power weighting factors to the UE.

21. The base station of claim 20, wherein the processor is further configured to configure UE individual power weighting factors to be used for weighting available UE transmit power between component carriers.

22. The base station of claim 21, wherein the processor is configured to prioritize component carriers by configuring the UE individual power weighting factors such that PUSCH power is first reduced on non-prioritised component carriers.

23. The base station of claim 20, wherein the processor is further configured to configure UE individual power weighting factors to be used for weighting available UE transmit power between PUCCH and PUSCH.

24. The base station of claim 23, wherein the processor is further configured to configure a PUCCH specific weighting factor to weight transmit power on PUCCH relative to transmit power on PUSCH or to weight the transmit power on PUSCH relative to the transmit power on PUCCH.

25. A Long Term Evolution (LTE) User Equipment (UE) for controlling transmit power of the UE, the UE comprising:
a receiver for receiving UE individual power weighting factors to be used for weighting available UE transmit power between uplink component carriers and/or between Physical Uplink Control Channel (PUCCH) and Physical Uplink Shared Channel (PUSCH); and
a processor for applying the received UE individual power weighting factors on the available UE transmit power during transmission.

26. The UE of claim 25, wherein the receiver is configured to receive UE individual power weighting factors and the processor is adapted to use them for weighting of available UE transmit power between component carriers.

27. The UE of claim 25, wherein the receiver is configured to receive UE individual power weighting factors and the processor is adapted to use them for weighting of available UE transmit power between PUCCH and PUSCH.

28. The UE of claim 27, wherein the receiver is configured to receive a PUCCH specific weighting factor to be used by the processor to weight transmit power on PUCCH relative to transmit power on PUSCH or to weight the transmit power on PUSCH relative to the transmit power on PUCCH.

29. The UE claim 25, wherein the processor is further configured to apply a respective scaling factor on the received weighting factors to scale the distributed available transmit power between component carriers and/or between PUSCH and PUCCH.
